(19) United States
(12) Patent Application Publication
(10) Pub. No.: US 2010/0250949 A1
(43) Pub. Date: Sep. 30, 2010

(54) GENERATION, REQUESTING, AND/OR RECEPTION, AT LEAST IN PART, OF TOKEN

(76) Inventors: Maria E. Torino, Cordoba (AR); Juan M. Da Cruz Pinto, Cordoba (AR); Ricardo A. Morin, Portland, OR (US); Jesse Walker, Portland, OR (US)

Correspondence Address: The Law Offices of Christopher K. Gagne;c/o CPA Global, B.O. Box 52050, Minneapolis, MN, 55402, US

(21) Appl. No.: 12/415,334

(22) Filed: Mar. 31, 2009

(51) Int. Cl. H04L 9/32; H04L 9/30

(52) U.S. Cl. 713/176; 380/30

(57) ABSTRACT

An embodiment may include circuitry to at least one of generate at least in part, receive at least in part, and request at least in part, a token. The token may identify, at least in part, a device to an entity. The token, as received by the entity, may be encrypted, at least in part, based at least in part upon the entity's public key. The token may be generated by an authorized provider of the token based at least in part upon an identifier of the device and a signature. The signature may be generated based at least in part upon the provider's private key and the identifier. The token, as received by the entity, may be capable of being decrypted at least in part, based at least in part upon the entity's private key. The entity's private key may be maintained in secrecy from the device and provider.

### FIELD

This disclosure relates to generation, requesting, and/or reception, at least in part, of a token.

### BACKGROUND

In one conventional arrangement, a user of a first network node initiates a transaction with a second network node. Software executing in the second network node tries to identify the user and/or the first network node in order to verify whether the user and/or the first network node are authorized to be involved in the transaction and have been involved in fraudulent transactions. Unfortunately, such identification/authentication techniques that are implemented using only software typically do not provide sufficiently secure execution or storage environments to prevent them from being relatively easily tricked (e.g., by use of virtualization techniques) into incorrectly identifying or authenticating malicious or unauthorized users or nodes.

One proposed solution has been to use standardized security hardware, in conjunction with software, to generate information (e.g., digital signatures) for use in the identification/authentication process. Unfortunately, these proposed techniques do not provide sufficient user privacy, especially in the case where a digital signature is directly used to identify or authenticate a user or node. Indeed, as a result of such identifying or authenticating techniques, different identifying or authenticating entities may generate essentially identical or correlated identifications for the same user or node, thereby resulting in substantially reduced privacy among such entities.

### BRIEF DESCRIPTION OF THE SEVERAL VIEWS OF THE DRAWINGS

Features and advantages of embodiments will become apparent as the following Detailed Description proceeds, and upon reference to the Drawings, wherein like numerals depict like parts, and in which:

FIG. 1 illustrates a system embodiment.

FIG. 2 illustrates circuitry in an embodiment.

FIG. 3 is a flowchart illustrating operations in an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRITPION

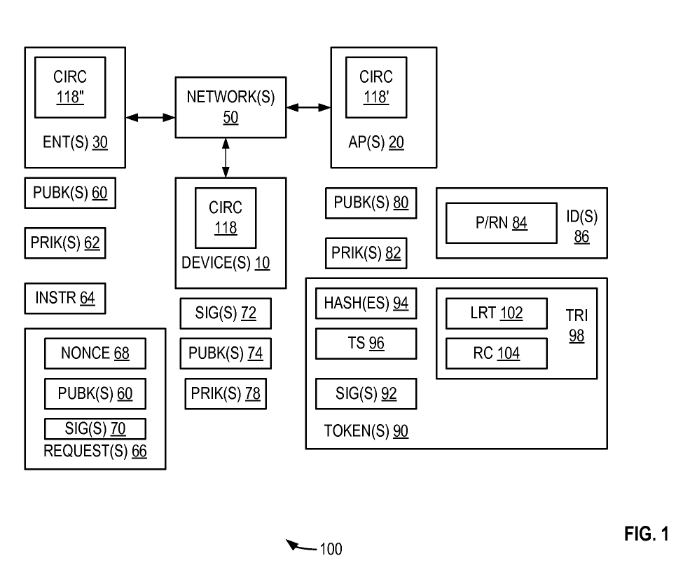

FIG. 1 illustrates a system embodiment 100. System 100 may include one or more devices 10, one or more authorized providers (AP) 20, and one or more entities (ENT) 30 that may be communicatively coupled together via one or more wireless and/or wired networks 50. In this embodiment, one or more devices 10, one or more AP 20, and/or one or more entities 30 may each comprise, for example, one or more end stations, appliances, intermediate stations, network interfaces, clients, servers, and/or portions thereof. In this embodiment, a “network” may be or comprise any mechanism, instrumentality, modality, and/or portion thereof that permits, facilitates, and/or allows, at least in part, two or more entities to be communicatively coupled together. Also in this embodiment, a first entity may be “communicatively coupled” to a second entity if the first entity is capable of transmitting to and/or receiving from the second entity one or more commands and/or data. In this embodiment, a “wireless network” means a network that permits, at least in part, at least two entities to be wirelessly communicatively coupled, at least in part. In this embodiment, a “wired network” means a network that permits, at least in part, at least two entities to be communicatively coupled, at least in part, via non-wireless means, at least in part. In this embodiment, data may be or comprise one or more commands, and/or one or more commands may be or comprise data.

One or more devices 10 may comprise circuitry (CIRC) 118. One or more AP 20 may comprise circuitry (CIRC) 118′. In this embodiment, one or more entities 30 may comprise circuitry (CIRC) 118″. The respective constructions of circuitry 118, 118′, and/or 118″ may be respectively substantially identical. However, without departing from this embodiment, the respective constructions of circuitry 118, 118′, and/or 118″ may differ in whole or in part from each other.

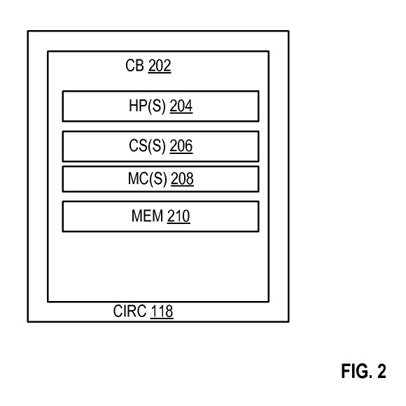

As shown in FIG. 2, circuitry 118 may comprise circuit board (CB) 202. CB 202 may be or comprise a system motherboard that may comprise one or more host processors (HP) 204, one or more chipsets (CS) 206, one or more microcontrollers (MC) 208, and computer-readable/writable memory (MEM) 210. In this embodiment, one or more host processors 204 may be communicatively coupled via one or more chipsets 206 to one or more microcontrollers 208 and memory 210. Although not shown in the Figures, alternatively, some or all of one or more microcontrollers 208 and/or memory 210, and/or some or all of the functionality and/or components thereof may be comprised in, for example, one or more host processors 204 and/or one or more chipsets 206. Additionally or alternatively, some or all of one or more chipsets 206, and/or some or all of the functionality and/or components thereof may be comprised in, for example, one or more host processors 204. As used herein, “circuitry” may comprise, for example, singly or in any combination, analog circuitry, digital circuitry, hardwired circuitry, programmable circuitry, state machine circuitry, and/or memory that may comprise program instructions that may be executed by programmable circuitry.

Each of the one or more host processors 204 and/or one or more chipsets 206 may comprise, for example, a respective Intel® microprocessor and/or chipset, respectively that are commercially available from the Assignee of the subject application. Of course, alternatively, each of the host processors 204 and/or one or more chipsets 206 may comprise a respective microprocessor and/or chipset, respectively, that is manufactured and/or commercially available from a source other than the Assignee of the subject application. In this embodiment, a “processor” and a “microcontroller” each may comprise respective circuitry capable of performing, at least in part, one or more arithmetic and/or logical operations. Also in this embodiment, a “chipset” may comprise circuitry capable of communicatively coupling, at least in part, one or more host processors, one or more microcontrollers, and/or memory. Although not shown in the Figures, circuitry 118 also may comprise a graphical user interface system that may comprise, e.g., a keyboard, pointing device, and display system that may permit a human user to input commands to, and monitor the operation of, one or more devices 10 and/or system 100.

One or more machine-readable program instructions may be stored in computer-readable/writable memory 210. In operation of one or more devices 10, these instructions may be accessed and executed by one or more host processors 204 and/or one or more microcontrollers 208. When executed by one or more host processors 204 and/or one or more microcontrollers 208, these one or more instructions may result in one or more host processors 204 and/or one or more microcontrollers 208 performing the operations described herein as being performed by one or more host processors 204 and/or microcontrollers 208. Memory 210 may comprise one or more of the following types of memories: semiconductor firmware memory, programmable memory, non-volatile memory, read only memory, electrically programmable memory, random access memory, flash memory, magnetic disk memory, optical disk memory, and/or other or later-developed computer-readable and/or writable memory.

In this embodiment, circuitry 118, 118′, and/or 118″ may be capable of exchanging data and/or commands via one or more networks 50 in accordance with one or more protocols. These one or more protocols may be compatible with, e.g., an Ethernet protocol, Transmission Control Protocol/Internet Protocol (TCP/IP) protocol, and/or Hypertext Transfer Protocol (HTTP) over Transport Layer Security (TLS) protocol.

The Ethernet protocol that may be utilized in system 100 may comply or be compatible with the protocol described in Institute of Electrical and Electronics Engineers, Inc. (IEEE) Std. 802.3, 2000 Edition, published on Oct. 20, 2000. The TCP/IP protocol that may be utilized in system 100 may comply or be compatible with the protocols described in Internet Engineering Task Force (IETF) Request For Comments (RFC) 791 and 793, published September 1981. The HTTP over TLS protocol (hereinafter referred to as “HTTPS”) that may be utilized in system 100 may comply or be compatible with the protocols described in IETF RFC 2818, published May 2000, and/or IETF RFC 4346, published April 2006. Although specific references will be made hereinafter to an embodiment that utilizes IP, TCP, and HTTPS, of course, many different, additional, and/or other protocols may be used for such data and/or command exchange without departing from this embodiment, including for example, later-developed versions of the aforesaid and/or other protocols.

In this embodiment, one or more microcontrollers 208, memory 210, and/or one or more portions thereof may comply and/or be compatible with Trusted Platform Model (TPM) Main Part 1 Design Principles, Specification Version 1.2, Level 2 Revision 103, Trusted Computing Group, Incorporated, published 9 Jul. 2007, and/or related, other, and/or additional TPM specifications. One or more microcontrollers 208 may be capable, at least in part, of implementing one or more cryptographic operations in accordance with the TPM described in one or more of these specifications.

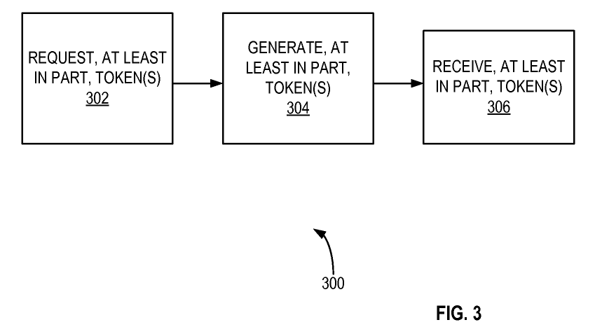

With particular reference now being made to FIGS. 1 and 3, operations 300 that may be performed in system 100 will be described. After a reset of system 100, a human user (not shown) of one or more devices 10 may initiate a transaction involving, for example, accessing via the not shown user interface of circuitry 118 a world wide web site associated with one or more entities 30. The web site may be hosted, at least in part, by the one or more entities 30 and/or other (not shown) entities in system 100. Such a transaction may involve, for example, accessing via the web site bank account information belonging to the user, attempting to transfer funds into and/or out of the bank account, etc. In response to and/or as a result of, at least in part, the initiation of the transaction, one or more entities 30 may initiate, at least in part, the issuance to and execution by, at least in part, one or more devices 10 of one or more instructions 64 and one or more requests 66.

One or more instructions (INSTR) 64 may be or comprise one or more dynamically-generated JavaScript™ web browser plug-in instructions in compliance and/or compatible with the JavaScript™ code version described in “Core JavaScript Guide 1.5 Guide,” published 20 Apr. 2005 by Mozilla Foundation, Mountain View, Calif., and/or later JavaScript™ code versions. Of course, without departing from this embodiment, other types of program instructions alternatively or additionally may be used.

One or more instructions 64 may be executed by one or more host processors 204 and/or one or more microcontrollers 208. The execution of one or more instructions 64 by one or more host processors 204 and/or microcontroller 208 may result in determination, at least in part, by one or more host processors 204 and/or one or more microcontrollers 208 of whether one or more instructions 64 have been previously downloaded to and/or are available for execution already (e.g., via operating system and/or web browser installation) in circuitry 118. If not, the execution by one or more host processors 204 and/or one or more microcontrollers 208 of one or more instructions 64 may result in completion of such downloading and/or such installation. After such downloading and/or installation has been completed, the execution of one or more instructions 64 may result in one or more host processors 204 and/or one or more microcontrollers 208 performing one or more operations involving and/or facilitating initialization and/or generation of cryptographic data structures for use in this embodiment. For example, these operations may permit one or more instructions 64 to take control, at least in part, of one or more microcontrollers 208, and may involve generation, at least in part, by one or more microcontrollers 208 of one or more TPM credentials (e.g., endorsement keys, attestation identity keys, direct anonymous attestation credentials, etc.) and/or one or more asymmetric key pairs (comprising one or more public keys (PUBK) 74 and one or more corresponding private keys (PRIK) 78) belong to and/or associated with one or more devices 10. These one or more TPM credentials and/or the one or more asymmetric key pairs may be for use by one or more devices 10 in operations directed to securely communicating with, and/or identifying and/or authenticating one or more devices 10 to one or more AP 20. One or more microcontrollers 208 may securely store these one or more TPM credentials and/or the one or more asymmetric key pairs in one or more microcontrollers 208 and/or memory 210. One or more devices 10 may maintain one or more private keys 78 in secrecy from one or more AP 20 and one or more entities 30.

In this embodiment, one or more requests 66 may request, at least in part, identification of one or more devices 10 (but not specifically of the particular user of one or more devices 10) to one or more entities 30. One or more requests 66 may comprise a nonce 68, one or more public keys (PUBK) 60 belonging to and/or associated with one or more entities 30, and one or more signatures (SIG) 70. One or more public keys 60 may be comprised in one or more asymmetric keys pairs belonging to and/or associated with one or more entities 30, which pairs may include one or more corresponding private keys (PRIK) 62. One or more private keys 62 may be maintained in secrecy from one or more devices 10 and one or more AP 20 by one or more entities 30. The execution by one or more host processors 204 and/or one or more microcontrollers 208 of one or more instructions 64 may result in one or more microcontrollers 208 generating, at least in part, one or more signatures (SIG) 72. One or more microcontrollers 208 may generate, at least in part, one or more signatures 72 based at least in part upon nonce 68 and one or more private keys (PRIK) 78. For example, one or more signatures 72 may be one or more asymmetric signatures of the nonce 68 using one or more private keys 78. Alternatively or additionally, one or more signatures 72 may be or comprise one or more asymmetric signatures, using one or more private keys 78, of one or more portions of the one or more requests 66, such as, the nonce 68, one or more public keys 60, and/or one or more signatures 70.

Thereafter, the execution of one or more instructions 64 by one or more host processors 204 and/or one or more microcontrollers 208 may result in circuitry 118 (e.g., one or more processors 204 and/or one or more microcontrollers 208) requesting, at least in part, from one or more AP 20 one or more tokens 90 (see operation 302 in FIG. 3). One or more tokens 90 may identify, at least in part, one or more devices 10 to one or more entities 30. For example, as part of operation 302, one or more processors 204 and/or one or more microcontrollers 208 may issue, at least in part, to one or more AP 20, as part of this request for one or more tokens 90, one or more requests 66, one or more signatures 72, and one or more public keys (PUBK) 74. One or more requests 66, one or more signatures 72, and/or one or more public keys 74 may be issued to one or more AP 20 using, for example, HTTPS, via one or more networks 50.

After receiving from one or more devices 10 the request for one or more tokens 90, circuitry 118′ in one or more AP 20 may generate, at least in part, one or more tokens 90 (see operation 304 in FIG. 3). For example, circuitry 118′ may determine, at least in part, whether one or more TPM credentials of one or more devices 10 are valid and/or authentic using conventional TPM techniques. Thereafter, circuitry 118′ may determine, at least in part, whether one or more signatures 72 and/or one or more signatures 70 are valid and/or authentic. Circuitry 118′ may validate and/or authenticate, at least in part, one or more signatures 72 based at least in part upon one or more asymmetric signature functions involving the nonce 68 and one or more public keys 74. Alternatively or additionally, circuitry 118′ may validate and/or authenticate, at least in part, one or more signatures 72 based at least in part upon one or more asymmetric signature functions, involving one or more public keys 74 and one or more portions of the one or more requests 66, such as, the nonce 68, one or more public keys 60, and/or one or more signatures 70. Circuitry 118′ may validate and/or authenticate, at least in part, one or more signatures 70 based at least in part upon one or more asymmetric signature functions involving the nonce 68 and one or more public keys 60. If circuitry 118′ determines, at least in part, that one or more signatures 70 or 72, or one or more of the TPM credentials are invalid or not authentic, circuitry 118′ may issue to one or more devices 10 an error code encrypted by one or more public keys 60.

Conversely, if circuitry 118′ determines, at least in part, that one or more signatures 70, 72, and one or more TPM credentials are valid and/or authentic, circuitry 118′ may determine whether a previous request was made to generate one or more tokens 90 to identify, at least in part, one or more devices 10. For example, circuitry 118′ may maintain one or more databases (not shown) and/or tables (not shown) that may correlate certain information (described below) associated with such requests and one or more tokens 90 in one or more entries that may be associated with one or more devices that may make such requests. If an entry is present in the one or more databases and/or tables that is associated with one or more devices 10, circuitry 118′ may utilize the information present in that entry (in accordance with the process described below) to generate, at least in part, one or more tokens 90.

Conversely, if no such entry is present in the one or more databases and/or tables, circuitry 118′ may generate such an entry in the one or more databases and/or tables that may be associated at least in part with one or more devices 10. The entry may include, for example, one or more public keys 74 of the one or more devices 10, and one or more identifiers (ID) 86 that may be associated with and/or identify, at least in part, one or more devices 10. The one or more identifiers 86 may be or comprise, at least in part, one or more random numbers and/or one or more pseudorandom numbers (collectively and/or singly referred to by P/RN 84 in FIG. 1). Circuitry 118′ may also generate and include in the entry a time stamp (TS) 96 indicative, at least in part, of the current time, and trust reputation information (TRI) 98. The TRI 98 may include a last reset time (LRT) 102 indicating, at least in part, when the one or more devices 10 last requested that one or more AP 20 reset one or more tokens 90, and a reset count (RC) 104 indicating, at least in part, the number of times that the one or more devices 10 have requested resetting of the one or more tokens 90 by one or more AP 20. When this entry is initially generated, the LRT 102 and RC 104 may be set to zero and/or null values. However, if the one or more devices 10 subsequently request resetting of the one or more tokens 90 (e.g., as a result of and/or to reflect change in ownership of the one or more devices 10), the LRT 102 and RC 104 values in the entry are updated appropriately. In general, an LRT 102 that indicates a relatively short time period from the present time to the time of the last reset request of one or more tokens 90, and/or a relatively high value of RC 104 may indicate that one or more devices 10 are to be treated as relatively less trustworthy. Conversely, if relatively longer time periods are indicated by LRT 102 and/or relatively low values of RC 104 are present, this may indicate that one or more devices 10 are to be treated as relatively more trustworthy.

After the entry has been generated, circuitry 118′ may generate, at least in part, one or more tokens 90 based at least in part upon the information comprised in the entry, and may issue, at least in part, the one or more tokens 90 to the one or more devices 10 via one or more networks 50. For example, in this embodiment, one or more tokens 90 may comprise one or more hash values 94, TS 96, TRI 98, and/or one or more signatures 92.

One or more hash values 94 may be generated, at least in part, by a cryptographic operation (e.g., hashing) involving one or more identifiers 86 and one or more public keys 60. For example, one or more identifiers 86 may undergo a bitwise logical OR operation with one or more public keys 60, or one or more identifiers 86 may be concatenated with one or more public keys 60. The result may then undergo a hashing operation. Depending upon the particular cryptographic operation that is employed, one or more hashes 94 may be used to identify (e.g., as one or more respective identifiers), at least in part, one or more devices 10 to one or more entities 30.

One or more signatures 92 may be one or more asymmetric signatures of the one or more hashes 94, TS 96, TRI 98, LRT 102, and/or RC 104, based at least in part upon and/or using one or more private keys (PRIK) 82. One or more private keys 82 may be comprised in one or more asymmetric key pairs (that may also comprise one or more corresponding public keys (PUBK) 80) that may belong to and/or be associated with one or more AP 20. One or more AP 20 may maintain the one or more private keys 82 in secrecy from the one or more devices 10 and the one or more entities 30.

After generating, at least in part, one or more tokens 90, circuitry 118′ may issue, at least in part, one or more tokens 90 via one or more networks 50. Circuitry 118 may receive, at least in part, one or more tokens 90, as illustrated by operation 306 in FIG. 3. However, prior to issuing, at least in part, one or more tokens 90 to circuitry 118, circuitry 118′ in one or more AP 20 may encrypt, at least in part, one or more tokens 90 based at least in part upon one or more public keys 60 of one or more entities 30. For example, circuitry 118′ may encrypt, at least in part, using one or more public keys 60, one or more hashes 94, TS 96, TRI 98, and/or one or more signatures 92. Therefore, as received by, at least in part, circuitry 118, one or more tokens 90 may be encrypted, at least in part, by the one or more public keys 60 of one or more entities 30.

After receiving, at least in part, one or more tokens 90, the execution of one or more instructions 64 by one or more host processors 204 and/or one or more microcontrollers 208 may result in circuitry 118 issuing, at least in part, one or more tokens 90 to one or more entities 30 (e.g., via the web site that is being accessed by the user of one or more devices 10) in response to the one or more requests 66. Circuitry 118″ in one or more entities 30 then may receive, at least in part, one or more tokens 90.

After receiving, at least in part, one or more tokens 90, circuitry 118″ may decrypt, at least in part, one or more tokens 90, based at least in part upon one or more private keys 62. Thereafter, one or more entities 30 may verify and/or authenticate, at least in part, one or more signatures 92, based at least in part upon one or more public keys 80, and one or more hashes 94, TS 96, TRI 98, LRT 102, and/or RC 104. If the decryption, verification, and/or authentication proceed to completion without error, one or more entities 30 may determine that the one or more devices 10 have successfully identified one or more devices 10 to one or more entities 30. The one or more entities 30 then may examine, for example, TRI 98 and/or other user/device behavior information to determine, at least in part, whether the transaction initiated by the user should be permitted to proceed. The one or more entities 30 may indicate this determination to the website, and the website may process the transaction in accordance with such indication. Conversely, if the decryption, verification, and/or authentication does not proceed to completion without error, one or more entities 30 may determine that the one or more devices 10 have not successfully identified one or more devices 10 to one or more entities 30, and may indicate to the website that the transaction initiated by the user should not be permitted to proceed.

In this embodiment, “encryption” and/or “encrypting” may comprise one or more operations comprised in, facilitating, and/or resulting in, at least in part, generation of cipher text from plaintext. Also in this embodiment, “decryption” and/or “decrypting” may comprise one or more operations comprised in, facilitating, and/or resulting in, at least in part, generation of plaintext from cipher text. In this embodiment, “plaintext” may include data that is, at least in part, encrypted and/or has already undergone and/or is presently undergoing encryption and/or decryption. Also in this embodiment, a “key” may comprise one or more symbols and/or values that may be used in encryption, decryption, authentication, and/or validation. In this embodiment, an “instruction” may include data and/or one or more commands. Additionally, in this embodiment, a “nonce” may comprise one or more symbols and/or values, such as, for example, a random or pseudorandom number, time of day, etc. In this embodiment, a “token” may comprise one or more symbols and/or values, and may (but is not required to) be used for the purpose of and/or to facilitate identification. Also in this embodiment, a “signature” may comprise one or more symbols and/or values, and may (but is not required to) be used for the purpose of and/or to facilitate verification and/or authentication.

Thus, an embodiment may include circuitry to at least one of generate at least in part, receive at least in part, and request at least in part, a token. The token may identify, at least in part, a device to an entity. The token, as received by the entity, may be encrypted, at least in part, based at least in part upon the entity's public key. The token may be generated by an authorized provider of the token based at least in part upon an identifier of the device and a signature. The signature may be generated based at least in part upon the provider's private key and the identifier. The token, as received by the entity, may be capable of being decrypted at least in part, based at least in part upon the entity's private key. The entity's private key may be maintained in secrecy from the device and provider.

Thus, in this embodiment, one or more AP 20 may constitute one or more protected execution environments (e.g., vis-á-vis one or more devices 10 and/or one or more entities 30) and may be provided to one or more entities in system 100 as one or more web service applications via one or more networks 50. The one or more web service applications essentially may be used as an identification, authentication, verification, and/or security intermediary/mediator to protect and/or maintain the privacy of the user in the above operations in system 100. The one or more web service applications may be used in conjunction with, for example, standards-based (e.g., TPM) hardware and security techniques (e.g., as implemented in circuitry 118).

Advantageously, this embodiment offers improved security compared to techniques that utilize software only, as well as, techniques that merely utilize standardized security hardware, in conjunction with software, to generate information (e.g., digital signatures) for use in the identification/authentication process. For example, in this embodiment, hardware microcontroller 208 may be utilized for at least some of the cryptographic operations implemented by one or more devices 10. Additionally, in this embodiment, one or more tokens 90, as issued from one or more AP 20, may be encrypted, at least in part, by one or more public keys 60. This may prevent all other entities in system 100, except for one or more entities 30 which possess one or more private keys 62, from being able to decrypt the encrypted one or more tokens 90. This may prevent all entities except one or more entities 30 from being able to use one or more tokens 90 in a meaningful way. Advantageously, this (either alone or in conjunction with other features of this embodiment, e.g., the use of one or more signatures 92) may permit the identification of one or more devices 10 by one or more tokens 90 in this embodiment to be more secure and less subject to trickery. Additionally, one or more tokens 90 in this embodiment may be generated, at least in part, upon P/RN 84 and one or more public keys 60. Advantageously, this may permit one or more tokens 90 in this embodiment to be substantially unique to both one or more devices 10 and one or more entities 30, thereby enhancing user privacy.

What is claimed is:

1. An apparatus comprising:
circuitry to at least one of generate at least in part, and receive at least in part, and request at least in part, a token to identify, at least in part, a device to an entity, the token, as received by the entity, being encrypted, at least in part, based at least in part upon a public key of the entity, the token being generated by an authorized provider of the token based at least in part upon an identifier of the device and a signature, the signature being generated based at least in part upon a private key of the authorized provider of the token and the identifier, the token, as received by the entity, being capable of being decrypted at least in part, based at least in part upon a private key of the entity, the private key of the entity being maintained in secrecy from the device and the authorized provider.

2. The apparatus of claim 1, wherein:
the signature is capable of being authenticated, at least in part, based at least in part upon a public key of the authorized provider; and
the identifier comprises at least in part at least one of a random number and a pseudorandom number generated at least in part by the authorized provider.

3. The apparatus of claim 2, wherein:
the private key of the authorized provider is maintained in secrecy from the device and the entity; and
the token is also generated based at least in part upon information indicative, at least in part, of a trust reputation of the device.

4. The apparatus of claim 3, wherein:
the information indicates, at least in part, a last reset time and a reset count, the last reset time indicating when the device last requested that the provider reset the token, the reset count indicating a number of times that the device has requested resetting of the token by the provider; and
the token is also generated based at least in part upon a cryptographic operation involving at least in part the identifier and the public key of the entity.

5. The apparatus of claim 1, wherein:
the device comprises a circuit board that comprises a host processor and a microcontroller coupled to a chipset, the microcontroller being to perform one or more cryptographic operations; and
the entity is to issue to the device one or more instructions and a request that comprises a nonce, the public key of the entity, and another signature, the one or more instructions to be executed, at least in part, by the device to result in the microcontroller generating, at least in part, a third signature based at least in part upon the nonce and a private key of the device, the request being to request identification of the device to the entity, the another signature being generated based at least in part upon the private key of the entity and the nonce.

6. The apparatus of claim 5, wherein:
the device is to issue to the authorized provider the request and the third signature; and
the authorized provider is to authenticate, respectively, the another signature based at least in part upon the nonce and the public key of the entity, and the third signature based at least in part upon the nonce and a public key of the device.

7. A method carried out at least in part by circuitry, the method comprising:
at least one of generating at least in part, and receiving at least in part, and requesting at least in part, a token to identify, at least in part, a device to an entity, the token, as received by the entity, being encrypted, at least in part, based at least in part upon a public key of the entity, the token being generated by an authorized provider of the token based at least in part upon an identifier of the device and a signature, the signature being generated based at least in part upon a private key of the authorized provider of the token and the identifier, the token, as received by the entity, being capable of being decrypted at least in part, based at least in part upon a private key of the entity, the private key of the entity being maintained in secrecy from the device and the authorized provider.

8. The method of claim 7, wherein:
the signature is capable of being authenticated, at least in part, based at least in part upon a public key of the authorized provider; and
the identifier comprises at least in part at least one of a random number and a pseudorandom number generated at least in part by the authorized provider.

9. The method of claim 8, wherein:
the private key of the authorized provider is maintained in secrecy from the device and the entity; and
the token is also generated based at least in part upon information indicative, at least in part, of a trust reputation of the device.

10. The method of claim 9, wherein:
the information indicates, at least in part, a last reset time and a reset count, the last reset time indicating when the device last requested that the provider reset the token, the reset count indicating a number of times that the device has requested resetting of the token by the provider; and
the token is also generated based at least in part upon a cryptographic operation involving at least in part the identifier and the public key of the entity.

11. The method of claim 7, wherein:
the device comprises a circuit board that comprises a host processor and a microcontroller coupled to a chipset, the microcontroller being to perform one or more cryptographic operations; and
the entity is to issue to the device one or more instructions and a request that comprises a nonce, the public key of the entity, and another signature, the one or more instructions to be executed, at least in part, by the device to result in the microcontroller generating, at least in part, a third signature based at least in part upon the nonce and a private key of the device, the request being to request identification of the device to the entity, the another signature being generated based at least in part upon the private key of the entity and the nonce.

12. The method of claim 11, wherein:
the device is to issue to the authorized provider the request and the third signature; and
the authorized provider is to authenticate, respectively, the another signature based at least in part upon the nonce and the public key of the entity, and the third signature based at least in part upon the nonce and a public key of the device.

13. Computer-readable memory storing one or more instructions that when executed by a machine result in execution of operations comprising:
at least one of generating at least in part, and receiving at least in part, and requesting at least in part, a token to identify, at least in part, a device to an entity, the token, as received by the entity, being encrypted, at least in part, based at least in part upon a public key of the entity, the token being generated by an authorized provider of the token based at least in part upon an identifier of the device and a signature, the signature being generated based at least in part upon a private key of the authorized provider of the token and the identifier, the token, as received by the entity, being capable of being decrypted at least in part, based at least in part upon a private key of the entity, the private key of the entity being maintained in secrecy from the device and the authorized provider.

14. The memory of claim 13, wherein:
the signature is capable of being authenticated, at least in part, based at least in part upon a public key of the authorized provider; and
the identifier comprises at least in part at least one of a random number and a pseudorandom number generated at least in part by the authorized provider.

15. The memory of claim 14, wherein:
the private key of the authorized provider is maintained in secrecy from the device and the entity; and
the token is also generated based at least in part upon information indicative, at least in part, of a trust reputation of the device.

16. The memory of claim 15, wherein:
the information indicates, at least in part, a last reset time and a reset count, the last reset time indicating when the device last requested that the provider reset the token, the reset count indicating a number of times that the device has requested resetting of the token by the provider; and
the token is also generated based at least in part upon a cryptographic operation involving at least in part the identifier and the public key of the entity.

17. The memory of claim 13, wherein:
the device comprises a circuit board that comprises a host processor and a microcontroller coupled to a chipset, the microcontroller being to perform one or more cryptographic operations; and
the entity is to issue to the device one or more additional instructions and a request that comprises a nonce, the public key of the entity, and another signature, the one or more additional instructions to be executed, at least in part, by the device to result in the microcontroller generating, at least in part, a third signature based at least in part upon the nonce and a private key of the device, the request being to request identification of the device to the entity, the another signature being generated based at least in part upon the private key of the entity and the nonce.

18. The memory of claim 17, wherein:
the device is to issue to the authorized provider the request and the third signature; and
the authorized provider is to authenticate, respectively, the another signature based at least in part upon the nonce and the public key of the entity, and the third signature based at least in part upon the nonce and a public key of the device.
